(19) United States
(12) Patent Application Publication
(10) Pub. No.: US 2025/0208495 A1
(43) Pub. Date: Jun. 26, 2025

(54) LIGHT SOURCE DEVICE AND PROJECTOR

(71) Applicant: SEIKO EPSON CORPORATION, Tokyo (JP)

(72) Inventor: Tomohiro YOKOO, MATSUMOTO-SHI (JP)

(21) Appl. No.: 18/989,060

(22) Filed: Dec. 20, 2024

(30) Foreign Application Priority Data
Dec. 21, 2023 (JP) 2023-215552

(51) Int. Cl. G03B 21/20; G03B 21/16

(52) U.S. Cl. CPC G03B 21/204; G03B 21/16; G03B 21/2013; G03B 21/2066

(57) ABSTRACT

A light source device includes a first light source configured to emit first light, a wavelength conversion element configured to convert the first light into second light, a first optical member that is disposed between the first light source and the wavelength conversion element and is configured to transmit the first light and reflect the second light, and a first reflective member configured to reflect the first light and the second light. A first air layer is disposed between the first optical member and the wavelength conversion element. The wavelength conversion element includes a first surface on which the first light is incident via the first optical member and the first air layer, a second surface facing to an opposite side to the first surface, and a third surface and a fourth surface crossing the first surface and the second surface and facing to respective sides opposite to each other. The first reflective member is disposed in a region at the third surface side of the first air layer. The second light emitted from the first surface of the wavelength conversion element propagates through the first air layer and is emitted from a region at the fourth surface side of the first air layer.

The present application is based on, and claims priority from JP Application Serial Number 2023-215552, filed Dec. 21, 2023, the disclosure of which is hereby incorporated by reference herein in its entirety.

### BACKGROUND

### 1. Technical Field

The present disclosure relates to a light source device and a projector.

### 2. Related Art

As a light source device used in a projector, there has been proposed a light source device using fluorescence emitted from a phosphor when the phosphor is irradiated with excitation light emitted from a light emitting element. WO 2006/054203 discloses a light source device including a wavelength conversion member that is shaped like a flat plate and includes a phosphor, and a light emitting diode that emits excitation light. In this light source device, the excitation light is incident from an incident surface large in area out of a plurality of surfaces of the wavelength conversion member, and fluorescence is emitted from an emission surface small in area.

WO 2006/054203 is an example of the related art.

In the light source device of WO 2006/054203, the fluorescence generated inside the wavelength conversion member is totally reflected at an interface between the surface of the wavelength conversion member and an air layer to thereby propagate inside the wavelength conversion member, and is then emitted from the emission surface. However, a component of the fluorescence that enters the interface between the wavelength conversion member and the air layer at an angle less than the critical angle is not totally reflected at the interface, and thus leaks to the outside from the interface before reaching the emission surface. Therefore, there is a problem that the use efficiency of the fluorescence degrades.

### SUMMARY

In order to solve the problems described above, a light source device according to an aspect of the present disclosure includes
a first light source configured to emit first light in a first wavelength band,
a wavelength conversion element configured to convert the first light into second light in a second wavelength band different from the first wavelength band,
a first optical member disposed between the first light source and the wavelength conversion element and configured to transmit the first light and reflect the second light, and
a first reflective member configured to reflect the first light and the second light. A first air layer is disposed between the first optical member and the wavelength conversion element. The wavelength conversion element includes a first surface on which the first light transmitted through the first optical member is incident via the first air layer, a second surface facing to an opposite side to the first surface, and a third surface and a fourth surface crossing the first surface and the second surface and facing to respective sides opposite to each other. The first reflective member is disposed in a region at the third surface side of the first air layer. The second light emitted from the first surface of the wavelength conversion element propagates through the first air layer and is emitted from a region at the fourth surface side of the first air layer.

A projector according to an aspect of the present disclosure includes the light source device according to the aspect of the present disclosure, a light modulation device configured to modulate light emitted from the light source device, and a projection optical device configured to project the light modulated by the light modulation device.

### BRIEF DESCRIPTION OF THE DRAWINGS

FIG. 1 is a schematic configuration diagram of a projector according to a first embodiment.

FIG. 2 is a perspective view of a light source device according to the first embodiment.

FIG. 3 is a cross-sectional view of the light source device along the line III-III in FIG. 2.

FIG. 4 is a cross-sectional view of the light source device along the line IV-IV in FIG. 2.

FIG. 5 is a schematic diagram illustrating functions and advantages of the light source device according to the present embodiment.

FIG. 6 is a cross-sectional view of a light source device according to a second embodiment.

FIG. 7 is a perspective view of a light source device according to a third embodiment.

FIG. 8 is a cross-sectional view of the light source device along the line VIII-VIII in FIG. 7.

FIG. 9 is a cross-sectional view of the light source device along the line IX-IX in FIG. 7.

FIG. 10 is a perspective view of a light source device according to a fourth embodiment.

FIG. 11 is a cross-sectional view of the light source device along the line XI-XI in FIG. 10.

FIG. 12 is a cross-sectional view of the light source device along the line XII-XII in FIG. 10.

FIG. 13 is a cross-sectional view of a light source device according to a fifth embodiment.

### DESCRIPTION OF EMBODIMENTS

### First Embodiment

A first embodiment of the present disclosure will hereinafter be described using the drawings.

A projector according to the present embodiment is an example of a projector using liquid crystal panels as light modulation devices.

In the following drawings, elements are drawn at different dimensional scales in some cases in order to make the elements eye-friendly.

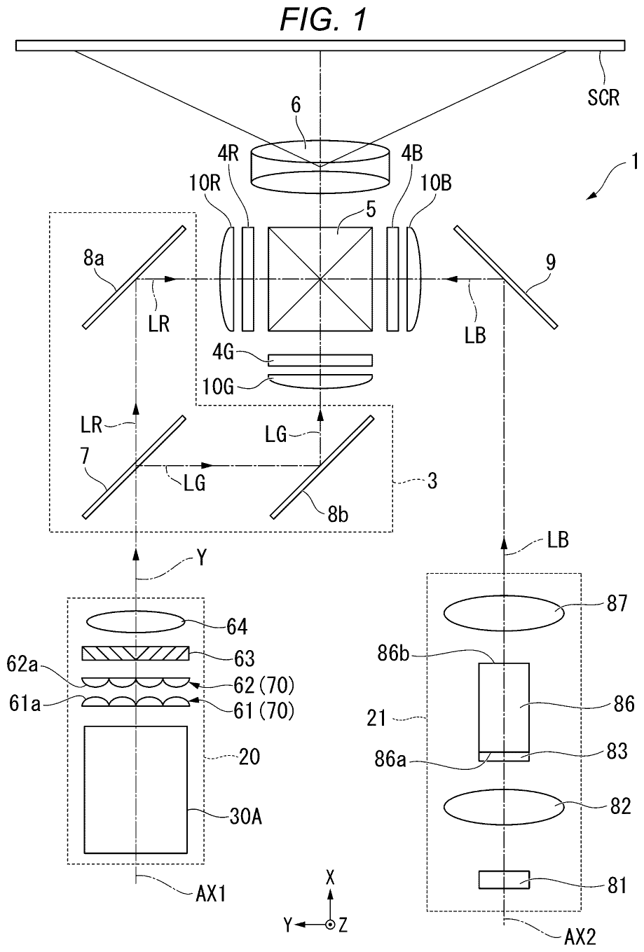

FIG. 1 is a schematic configuration diagram of the projector 1 according to the present embodiment.

As shown in FIG. 1, the projector 1 according to the present embodiment is a projection-type image display apparatus that displays a color image on a screen SCR as a projection target surface. The projector 1 includes three light modulation devices corresponding respectively to color light beams, namely red light LR, green light LG, and blue light LB.

The projector 1 includes a first illumination device 20, a second illumination device 21, a color separation optical system 3, a light modulation device 4R, a light modulation device 4G, a light modulation device 4B, a light combining element 5, and a projection optical device 6.

The first illumination device 20 outputs yellow fluorescence Y toward the color separation optical system 3. The second illumination device 21 emits the blue light LB toward the light modulation device 4B. Detailed configurations of the first illumination device 20 and the second illumination device 21 will be described later.

The description with reference to the drawings will hereinafter be made using an X-Y-Z orthogonal coordinate systemin as needed. The Z axis is an axis extending along the vertical direction of the projector 1. The X axis is an axis parallel to an optical axis AX1 of the first illumination device 20 and an optical axis AX2 of the second illumination device 21, and is an axis along the front-back direction of the projector 1. The Y axis is an axis orthogonal to the X axis and the Z axis, and is an axis along the left-right direction of the projector 1. These notations are for describing the arrangement relationship of the constituent members of the projector 1, and do not limit an installation posture and a direction of the projector 1. The optical axis AX1 of the first illumination device 20 is the central axis of the fluorescence Y emitted from the first illumination device 20. The optical axis AX2 of the second illumination device 21 is the central axis of the blue light LB emitted from the second illumination device 21.

One of both directions along the X axis is referred to as a +X direction, and an opposite direction thereof is referred to as a −X direction. One of both directions along the Y axis is referred to as a +Y direction, and an opposite direction thereof is referred to as a −Y direction. One of both directions along the Z axis is referred to as a +Z direction, and an opposite direction thereof is referred to as a −Z direction. The two directions along the X axis are collectively referred to as an X-axis direction when they are not distinguished from each other. The two directions along the Y axis are collectively referred to as a Y-axis direction when they are not distinguished from each other. The two directions along the Z axis are collectively referred to as a Z-axis direction when they are not distinguished from each other.

The color separation optical system 3 separates the yellow fluorescence Y emitted from the first illumination device 20 into the red light LR and the green light LG. The color separation optical system 3 includes a dichroic mirror 7, a first reflecting mirror 8a, and a second reflecting mirror 8b.

The dichroic mirror 7 separates the fluorescence Y into the red light LR and the green light LG. The dichroic mirror 7 transmits the red light LR and reflects the green light LG. The second reflecting mirror 8b is disposed in the light path of the green light LG. The second reflecting mirror 8b reflects the green light LG, which has been reflected by the dichroic mirror 7, toward the light modulation device 4G. The first reflecting mirror 8a is disposed in the light path of the red light LR. The first reflecting mirror 8a reflects the red light LR, which has passed through the dichroic mirror 7, toward the light modulation device 4R.

In contrast, the blue light LB emitted from the second illumination device 21 is reflected by a reflecting mirror 9 toward the light modulation device 4B.

The configuration of the second illumination device 21 will hereinafter be described.

The second illumination device 21 includes a light source unit 81, a light collection lens 82, a diffuser plate 83, a rod lens 86, and a relay lens 87. The light source unit 81 is configured with at least one semiconductor laser. The light source unit 81 emits the blue light LB as laser light. Note that the light source unit 81 is not necessarily configured with a semiconductor laser, but may be configured with an LED that emits blue light.

The light collection lens 82 is configured with a convex lens. The light collection lens 82 causes the blue light LB emitted from the light source unit 81 to enter the diffuser plate 83 in substantially converged state. The diffuser plate 83 diffuses the blue light LB emitted from the light collection lens 82 with a predetermined degree of diffusion to generate the blue light LB having a substantially uniform light distribution similar to that of the fluorescence Y emitted from the first illumination device 20. As the diffuser plate 83, for example, ground glass made of optical glass is used.

The blue light LB diffused by the diffuser plate 83 enters the rod lens 86. The rod lens 86 has a prismatic shape extending along the direction of the optical axis AX2 of the second illumination device 21. The rod lens 86 has an end plane of incidence of light 86a disposed at one end and a light exit end surface 86b disposed at the other end. The diffuser plate 83 is fixed to the end plane of incidence of light 86a of the rod lens 86 via an optical adhesive (not shown). It is desirable that the refractive index of the diffuser plate 83 matches as much as possible with the refractive index of the rod lens 86.

The blue light LB propagates through the interior of the rod lens 86 while being totally reflected therein to thereby be emitted from the light exit end surface 86b in a state in which the uniformity of the illuminance distribution is enhanced. The blue light LB emitted from the rod lens 86 enters the relay lens 87. The relay lens 87 makes the blue light LB enhanced in the uniformity of the illuminance distribution by the rod lens 86 enter the reflecting mirror 9.

The light exit end surface 86b of the rod lens 86 has a rectangular shape substantially similar to the shape of an image formation region of the light modulation device 4B. This makes the blue light LB emitted from the rod lens 86 efficiently enter the image formation region of the light modulation device 4B.

The light modulation device 4R modulates the red light LR in accordance with image information to form image light corresponding to the red light LR. The light modulation device 4G modulates the green light LG in accordance with the image information to form image light corresponding to the green light LG. The light modulation device 4B modulates the blue light LB in accordance with the image information to form image light corresponding to the blue light LB.

As each of the light modulation devices 4R, 4G, and 4B, there is used, for example, a transmissive liquid crystal panel. Polarization plates (not shown) are disposed at light incident side and light exit side of the liquid crystal panel, respectively. The polarization plates only transmit linearly polarized light polarized in a specific direction.

At the incident side of the light modulation device 4R, there is disposed a field lens 10R. At the incident side of the light modulation device 4G, there is disposed a field lens 10G. At the incident side of the light modulation device 4B, there is disposed a field lens 10B. The field lens 10R collimates a principal ray of the red light LR to be incident on the light modulation device 4R. The field lens 10G collimates a principal ray of the green light LG to be incident on the light modulation device 4G. The field lens 10B collimates a principal ray of the blue light LB to be incident on the light modulation device 4B.

Upon incidence of the image light emitted from the light modulation device 4R, the image light emitted from the light modulation device 4G, and the image light emitted from the light modulation device 4B synthesizes image light corresponding to the red light LR, the green light LG, and the blue light LB to output the image light thus synthesized toward the projection optical device 6. As the light combining element 5, there is used, for example, a cross dichroic prism.

The projection optical device 6 is configured with a plurality of projection lenses. The projection optical device 6 projects the image light synthesized by the light combining element 5 toward the screen SCR in an enlarged manner. Thus, an image is displayed on the screen SCR.

The configuration of the first illumination device 20 will hereinafter be described.

The first illumination device 20 includes a light source device 30A, an integrator optical system 70, a polarization conversion element 63, and a superimposing optical system 64.

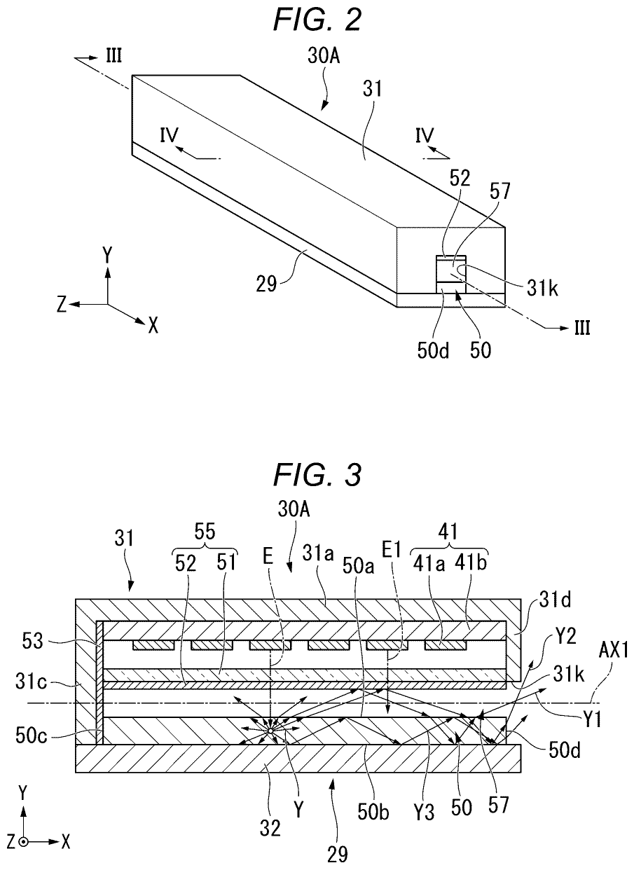

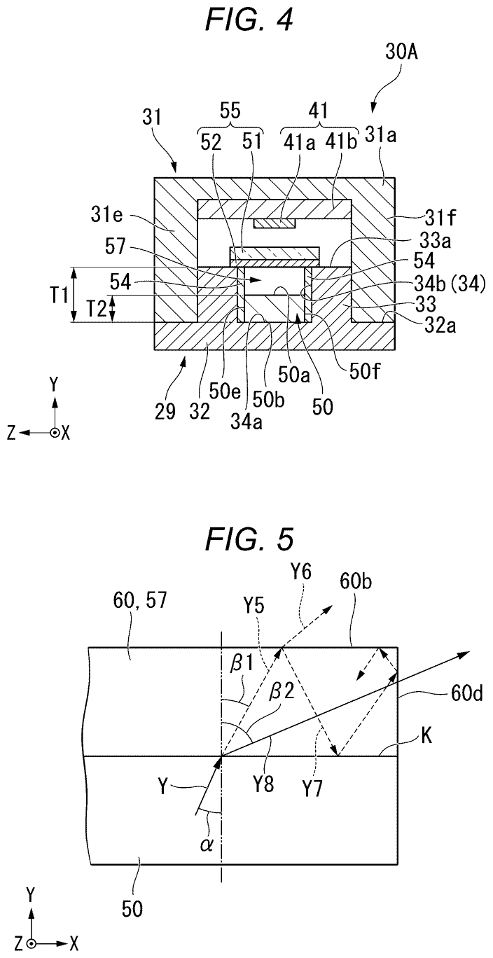

FIG. 2 is a perspective view of the light source device 30A according to the present embodiment. FIG. 3 is a cross-sectional view of the light source device 30A along the line III-III in FIG. 2. FIG. 4 is a cross-sectional view of the light source device 30A along the line IV-IV in FIG. 2.

As shown in FIGS. 2 to 4, the light source device 30A includes a support member 29, a housing 31, a first light source 41, a wavelength conversion element 50, a first optical member 55, a first reflective member 53, and second reflective members 54.

The support member 29 supports the wavelength conversion element 50. The wavelength conversion element 50 is coupled to the support member 29 so as to be able to transfer heat. Accordingly, the support member 29 functions as a heat dissipation member that diffuses heat generated in the wavelength conversion element 50 to release the heat to the outside. It is therefore desirable for the support member 29 to be formed of a material that has predetermined strength and high thermal conductivity. As the material of the support member 29, metal such as aluminum or stainless steel is used, and in particular, an aluminum alloy such as a 6061 aluminum alloy is desirably used. According to this configuration, since the heat of the wavelength conversion element 50 is dissipated to the outside via the support member 29, a rise in the temperature of the wavelength conversion element 50 can be suppressed. As a result, it is possible to suppress a decrease in wavelength conversion efficiency due to a temperature rise of the wavelength conversion element 50.

As shown in FIG. 4, the support member 29 includes a base part 32 and a support part 33. The base part 32 is a plate-shaped member forming a main body of the support member 29 and extends long in the X-axis direction. The support part 33 is formed integrally with the base part 32 and is disposed on a surface 32a of the base part 32 located at the +Y side thereof. The support part 33 has a groove 34 which supports the wavelength conversion element 50. The groove 34 extends in the X-axis direction along the longitudinal direction of the support part 33 and houses the wavelength conversion element 50. The groove 34 includes a bottom surface 34a along the X-Z plane, and a pair of inner wall surfaces 34b which are disposed at a distance from each other in the Z-axis direction and are in parallel to the X-Y plane. A pair of second reflective members 54 described later are respectively disposed on the inner wall surfaces 34b of the groove 34. In the present embodiment, the height T1 in the Y-axis direction of the support part 33 is higher than the height T2 in the Y-axis direction of the wavelength conversion element 50.

As shown in FIG. 2, the housing 31 constitutes the exterior of the light source device 30A together with the support member 29. The housing 31 has a substantially box shape with one surface opened. The housing 31 includes a top wall part 31a, a first sidewall part 31c, a second sidewall part 31d, a third sidewall part 31e, a fourth sidewall part 31f, and a light drawing port 31k.

The top wall part 31a is disposed along the X-Z plane. The first sidewall part 31c and the second sidewall part 31d cross the X axis parallel to the longitudinal direction of the wavelength conversion element 50 and are located at respective sides opposite to each other in the X-axis direction. The first sidewall part 31c is located at −X side which is one side in the X-axis direction. The second sidewall part 31d is located at +X side which is the other side in the X-axis direction. The third sidewall part 31e and the fourth sidewall part 31f are located at respective sides opposite to each other in the Z-axis direction crossing the longitudinal direction of the wavelength conversion element 50. In the present embodiment, the third sidewall part 31e is located at +Z side which is one side in the Z-axis direction. The fourth sidewall part 31f is located at −Z side which is the other side in the Z-axis direction.

The first light source 41 is disposed on the top wall part 31a of the housing 31. The first reflective member 53 is disposed on the first sidewall part 31c of the housing 31. The light drawing port 31k is provided to the second sidewall part 31d of the housing 31. The light drawing port 31k is an opening for drawing the fluorescence Y emitted from the first air layer 57 and the wavelength conversion element 50 to the outside.

The top wall part 31a is coupled to the first light source 41 so as to be able to transfer heat. It is therefore desirable that the housing 31 is made of a material having predetermined strength and high thermal conductivity. As the material of the housing 31, metal such as aluminum or stainless steel is used, and in particular, an aluminum alloy such as a 6061 aluminum alloy is desirably used similarly to the material of the support member 29.

The housing 31 is disposed so as to cover the support part 33 of the support member 29 and to be stopped at the surface 32a of the base part 32 of the support member 29. That is, the housing 31 covers the first optical member 55 and the wavelength conversion element 50 supported by the groove 34. The housing 31 and the support member 29 are fixed to each other via a fixing member such as an adhesive or a screw (not shown).

As described above, in the light source device 30A, the first optical member 55, the wavelength conversion element 50, and the first light source 41 are housed in a space surrounded by the housing 31 and the support member 29. This makes it possible to suppress adhesion of foreign matter such as dust to the first optical member and the wavelength conversion element 50.

The first light source 41 includes a plurality of first light emitting elements 41a and a substrate 41b. The plurality of first light emitting elements 41a is mounted on the substrate 41b. Note that the number of the first light emitting elements 41a is not particularly limited. Accordingly, the first light source 41 is not required to include two or more first light emitting elements 41a, but may include a single first light emitting element 41a.

The first light emitting elements 41a each emit an excitation light beam E1 in a first wavelength band. The first light emitting elements 41a are each configured with, for example, a light emitting diode (LED). The first light emitting element 41a is disposed to be opposed to the wavelength conversion element 50 and emits the excitation light beam E1 toward the wavelength conversion element 50. The first wavelength band is, for example, a violet-to-blue wavelength band ranging from 400 nm to 480 nm and has a peak wavelength of, for example, 445 nm. The plurality of first light emitting elements 41a are arranged along the X-axis direction which is the longitudinal direction of the wavelength conversion element 50. In this manner, the first light source 41 emits excitation light E consisting of the plurality of blue excitation light beams E1 toward the wavelength conversion element 50.

The wavelength conversion element 50 has a plate-like shape extending along the X axis and has six surfaces. The sides of the wavelength conversion element 50 extending along the X axis are longer than the sides thereof extending along the Y axis and the sides thereof extending along the Z axis. The X-axis direction corresponds to the longitudinal direction of the wavelength conversion element 50. The Y-axis direction is a direction parallel to the shortest side of the sides of the wavelength conversion element 50. The sides along the Y axis are shorter than the sides along the Z axis. That is, the cross-sectional shape of the wavelength conversion element 50 cut with a plane along the Y-Z plane is a rectangular shape as shown in FIG. 4.

The wavelength conversion element 50 has an obverse surface 50a, a reverse surface 50b, a first end surface 50c, a second end surface 50d, a first side surface 50e, and a second side surface 50f. The obverse surface 50a and the reverse surface 50b cross the Y axis and face to respective sides opposite to each other in the Y axis. In the present embodiment, the obverse surface 50a is a surface located at the +Y side which is one side in the Y-axis direction. The reverse surface 50b is a surface located at the −Y side, which is the other side in the Y-axis direction, and is in contact with the bottom surface 34a of the groove 34 of the support member 29. That is, the reverse surface 50b of the wavelength conversion element 50 is coupled to the support member 29 so as to be able to transfer heat. The excitation light E enters the obverse surface 50a via the first optical member 55 and the first air layer 57. The obverse surface 50a in the present embodiment corresponds to a first surface in the appended claims. The reverse surface 50b in the present embodiment corresponds to a second surface in the appended claims. Note that a reflective film may be formed on the reverse surface 50b of the wavelength conversion element 50 to form a configuration in which the fluorescence Y emitted from the reverse surface 50b may be reflected by the reflective film to be returned into the wavelength conversion element 50.

As illustrated in FIG. 3, the first end surface 50c and the second end surface 50d cross the obverse surface 50a and the reverse surface 50b, and face to respective sides opposite to each other in the X-axis direction along the longitudinal direction of the wavelength conversion element 50. In the present embodiment, the first end surface 50c is located at the −X side which is one side in the X-axis direction. The second end surface 50d is located at the +X side which is the other side in the X-axis direction. The first end surface 50c in the present embodiment corresponds to a third surface in the appended claims. The second end surface 50d in the present embodiment corresponds to a fourth surface in the appended claims.

As shown in FIG. 4, the first side surface 50e and the second side surface 50f cross the obverse surface 50a, the reverse surface 50b, the first end surface 50c, and the second end surface 50d, and face to respective sides opposite to each other in the Z-axis direction. In the present embodiment, the first side surface 50e is located at the +Z side which is one side in the Z-axis direction, and the second side surface 50f is located at the −Z side which is the other side in the Z-axis direction. The first side surface 50e in the present embodiment corresponds to a fifth surface in the appended claims. The second side surface 50f in the present embodiment corresponds to a sixth surface in the appended claims.

The wavelength conversion element 50 includes at least a yellow phosphor, and converts the excitation light E in the first wavelength band emitted from the plurality of light emitting elements 41a of the first light source 41 into the yellow fluorescence Y in the second wavelength band different from the first wavelength band. The excitation light E enters the wavelength conversion element 50 from the obverse surface 50a via the first optical member 55 and the first air layer 57. Further, the fluorescence Y generated inside the wavelength conversion element 50 is emitted from the obverse surface 50a to the first air layer 57. The excitation light E in the present embodiment corresponds to first light in the appended claims.

The wavelength conversion element 50 includes a ceramic phosphor formed of a polycrystalline phosphor that performs the wavelength conversion on the excitation light E into the fluorescence Y. The wavelength conversion element 50 of the present embodiment is formed of a phosphor having no light scattering property, that is, a so-called transparent phosphor. The second wavelength band provided to the fluorescence Y is a yellow wavelength band ranging, for example, from 490 to 750 nm. That is, the fluorescence Y is yellow fluorescence containing a red light component and a green light component. The fluorescence Y in the present embodiment corresponds to second light in the appended claims.

The wavelength conversion element 50 may include a single crystal phosphor instead of the polycrystalline phosphor. Alternatively, the wavelength conversion element 50 may be formed of fluorescent glass. Alternatively, the wavelength conversion element 50 may be configured with a material obtained by dispersing a large number of phosphor particles in a binder made of glass or resin. The wavelength conversion element 50 made of such a material as described above converts the excitation light E into the fluorescence Y.

Specifically, the material of the wavelength conversion element 50 includes, for example, an yttrium-aluminum-garnet-based (YAG-based) phosphor. Consider YAG: Ce, which contains cerium (Ce) as an activator, by way of example, and the wavelength conversion element 50 is made, for example, of a material produced by mixing raw powder materials containing Y₂O₃, Al₂O₃, CeO₃, and other constituent elements with one another and causing the mixture to go through a solid-phase reaction, Y—Al—O amorphous particles produced by using a coprecipitation method, a sol-gel method, or any other wet method, or YAG particles produced by using a spray-drying method, a flame-based thermal decomposition method, a thermal plasma method, or any other gas-phase method.

The first optical member 55 is disposed between the first light source 41 and the wavelength conversion element 50. Specifically, as shown in FIG. 4, the first optical member 55 is disposed on a surface 33a of the support part 33 opposed to the first light source 41. The first optical member 55 includes a first light transmissive member 51 and a first optical layer 52.

The first light transmissive member 51 is made of a light transmissive material such as borosilicate glass such as BK7, quartz, synthetic quartz, quartz crystal, SiC, GaN, MgO, YAG, sapphire, or diamond. The first light transmissive member 51 needs to be made of a material capable of transmitting at least the excitation light E. The first light transmissive member 51 has a plate shape extending along the X axis. As shown in FIG. 4, the cross-sectional surface of the first light transmissive member 51 cut with a plane parallel to the Y-Z plane has a rectangular shape which extends long in the X-axis direction.

Note that the thermal conductivity of the first light transmissive member 51 is preferably higher than the thermal conductivity of the wavelength conversion element 50. Examples of the material of the first light transmissive member 51 that satisfies this relationship include SiC, GaN, MgO, YAG, sapphire, and diamond. According to this configuration, since the heat of the wavelength conversion element 50 is efficiently transferred to the first light transmissive member 51 via the first air layer 57, it is possible to suppress the temperature rise of the wavelength conversion element 50. Accordingly, it is possible to suppress a decrease in light emission efficiency due to a rise in temperature of the wavelength conversion element 50.

The first optical layer 52 has optical characteristics of transmitting the excitation light E and reflecting the fluorescence Y. The first optical layer 52 is formed of, for example, a dielectric multilayer film. The first optical layer 52 is disposed between the wavelength conversion element 50 and the first light transmissive member 51. That is, the first optical layer 52 is disposed on a surface opposed to the wavelength conversion element 50 out of the two surfaces of the first light transmissive member 51. According to this configuration, as will be described later, since the fluorescence Y does not enter the first light transmissive member 51 and does not propagate through the inside of the first light transmissive member 51, the loss of the fluorescence Y can be kept to the minimum.

The first air layer 57 is disposed between the first optical member 55 and the wavelength conversion element 50. That is, the first optical member 55 and the wavelength conversion element 50 are disposed apart from each other, and air is present between the first optical member 55 and the wavelength conversion element 50. In the case of the present embodiment, since the height T1 in the Y-axis direction of the support part 33 is higher than the height T2 in the Y-axis direction of the wavelength conversion element 50, and the first optical member 55 is disposed on the surface 33a of the support part 33 opposed to the first light source 41, a state in which the first air layer 57 is present between the first optical member 55 and the wavelength conversion element 50 is stably maintained.

As illustrated in FIG. 3, the first reflective member 53 is disposed at the −X side in the X-axis direction of the wavelength conversion element 50, the first air layer 57, the first optical member 55, and the first light source 41. The first reflective member 53 is disposed on the first sidewall part 31c of the housing 31 so as to be opposed to the first end surface 50c of the wavelength conversion element 50, a region at the first end surface 50c side of the first air layer 57, an end surface at the first end surface 50c side of the first optical member 55, and an end surface at the first end surface 50c side of the first light source 41. Note that the first reflective member 53 is not necessarily required to be disposed over the entire region described above, and may be disposed in at least a region at the first end surface 50c side of the first air layer 57.

The first reflective member 53 reflects the fluorescence Y that has propagated inside the first air layer 57 and the wavelength conversion element 50 and has reached the first reflective member 53. Further, the first reflective member 53 reflects the excitation light E that has been reflected by the obverse surface 50a of the wavelength conversion element 50, has propagated inside the first air layer 57, and has reached the first reflective member 53. That is, the first reflective member 53 reflects the fluorescence Y and the excitation light E. The first reflective member 53 is configured with, for example, a metal film, a dielectric multilayer film, or a scattering member made of barium sulfate.

As shown in FIG. 4, the pair of second reflective members 54 are located at both sides in the Z-axis direction of the first air layer 57 and the wavelength conversion element 50. One of the second reflective members 54 is disposed on the inner wall surface 34b of the groove 34 of the support member 29 so as to be opposed to a region at the first side surface 50e side of the wavelength conversion element 50 and a region at the first side surface 50e side of the first air layer 57. The other of the second reflective members 54 is disposed on the inner wall surface 34b of the groove 34 of the support member 29 so as to be opposed to a region at the second side surface 50f side of the wavelength conversion element 50 and a region at the second side surface 50f side of the first air layer 57.

The second reflective member 54 reflects the excitation light E that has been reflected by the obverse surface 50a of the wavelength conversion element 50, has entered the first air layer 57, and then has reached the second reflective member 54, to thereby make the excitation light E enter the wavelength conversion element 50. Thus, the conversion efficiency from the excitation light E into the fluorescence Y can be increased. Further, the second reflective member 54 reflects the fluorescence Y that has been emitted from the wavelength conversion element 50, has entered the first air layer 57, and has reached the second reflective member 54, and the fluorescence Y that has been guided inside the wavelength conversion element 50 and has reached the second reflective member 54. Accordingly, the loss of the fluorescence Y can be suppressed. That is, the second reflective members 54 reflect the fluorescence Y and the excitation light E. The second reflective members 54 are each configured with, for example, a metal film, a dielectric multilayer film, or a scattering member.

As illustrated in FIG. 1, the integrator optical system 70 is disposed at the light exit side of the light source device 30A. The integrator optical system 70 includes a first lens array 61 and a second lens array 62. The integrator optical system 70, along with the superimposing optical system 64, functions as a homogenous illumination optical system that homogenizes the intensity distribution of the fluorescence Y emitted from the light source device 30A in each of the light modulation devices 4R, 4G, which are illumination target regions. The fluorescence Y emitted from the light source device 30A enters the first lens array 61.

The first lens array 61 includes a plurality of first lenses 61a. The plurality of first lenses 61a is arranged in a matrix in a plane parallel to the Y-Z plane perpendicular to the optical axis AX1 of the first illumination device 20. The plurality of first lenses 61a divides the fluorescence Y emitted from the light source device 30A into a plurality of partial luminous fluxes. The first lenses 61a each have a rectangular shape substantially similar to the shape of the image formation region of each of the light modulation devices 4R, 4G. Thus, the partial fluxes emitted from the first lens array 61 are each efficiently incident on the image formation region of each of the light modulation devices 4R, 4G.

The fluorescence Y emitted from the first lens array 61 travels toward the second lens array 62. The second lens array 62 is disposed so as to be opposed to the first lens array 61. The second lens array 62 includes a plurality of second lenses 62a corresponding to the plurality of first lenses 61a of the first lens array 61. The second lens array 62 forms images of the plurality of first lenses 61a of the first lens array 61 in the vicinity of the image formation region of each of the light modulation devices 4R, 4G in cooperation with the superimposing optical system 64. The plurality of second lenses 62a is arranged in a matrix in a plane parallel to the Y-Z plane perpendicular to the optical axis AX1 of the first illumination device 20. The superimposing optical system 64 is configured with a single convex lens.

The first lenses 61a of the first lens array 61 and the second lenses 62a of the second lens array 62 are the same in size as each other in the present embodiment, but may be different in size from each other. Further, the first lenses 61a of the first lens array 61 and the second lenses 62a of the second lens array 62 are arranged at positions where the optical axes thereof coincide with each other in the present embodiment, but may be arranged at positions where the optical axes thereof deviate from each other.

The polarization conversion element 63 converts the polarization direction of the fluorescence Y emitted from the second lens array 62. Specifically, the polarization conversion element 63 converts each of the partial fluxes of the fluorescence Y divided by the first lens array 61 and then emitted from the second lens array 62 into linearly polarized light. The polarization conversion element 63 includes a polarization separation layer (not shown), a reflective layer (not shown), and a retardation layer (not shown). The polarization separation layer transmits one of the linear polarization components contained in the fluorescence Y emitted from the light source device 30A as it is, and reflects the other of the linear polarization components in a direction perpendicular to the optical axis AX1. The reflective layer reflects the other linear polarization component reflected by the polarization separation layer in a direction parallel to the optical axis AX1. The retardation layer converts the other linear polarization component reflected by the reflective layer into the one linear polarization component.

The behavior of the light in the light source device 30A according to the present embodiment will hereinafter be described.

As shown in FIG. 3, in the light source device 30A, the excitation light E emitted from the first light source 41 is transmitted through the first light transmissive member 51 and the first optical layer 52, and then enters the wavelength conversion element 50 via the first air layer 57. Note that a part of the excitation light E is backscattered by the obverse surface 50a of the wavelength conversion element 50 and travels toward the first light source 41, but is reflected by the first optical layer 52 and the first light transmissive member 51 and then enters the wavelength conversion element 50.

When the excitation light E enters wavelength conversion element 50, the phosphor contained in the wavelength conversion element 50 is excited, and emits the fluorescence Y from random light emission points. On this occasion, there occurs a so-called smear of the fluorescence Y in which the excitation light E having entered the phosphor is diffused and propagates to a region wider than the region on which the excitation light E is incident to thereby widen the width of the region from which the fluorescence Y is emitted.

The fluorescence Y which enters the obverse surface 50a of the wavelength conversion element 50 at an incident angle less than the critical angle is emitted from the wavelength conversion element 50, enters the first air layer 57, and propagates inside the first air layer 57. On this occasion, the fluorescence Y1 traveling toward the +X side is reflected by the first optical layer 52 of the first optical member 55 and enters the wavelength conversion element 50 again. In the case of the present embodiment, since the wavelength conversion element 50 is formed of a transparent phosphor, scattering of the fluorescence Y does not occur inside the wavelength conversion element 50, and the traveling direction of fluorescence Y1 which travels inside the wavelength conversion element 50 does not change. Therefore, the fluorescence Y1 is reflected by the reverse surface 50b of the wavelength conversion element 50, enters the first air layer 57 from the obverse surface 50a of the wavelength conversion element 50, and is emitted from the region at the second end surface 50d side of the first air layer 57. Further, fluorescence Y2, which is reflected by the first optical layer 52 of the first optical member 55, enters the wavelength conversion element 50, and is reflected by the reverse surface 50b, is emitted from the second end surface 50d.

That is, the fluorescence Y propagates inside the first air layer 57 and the wavelength conversion element 50 while repeating reverse surface reflection by the wavelength conversion element 50 and reflection by the first optical layer 52, and is then emitted from the region at the second end surface 50d side of the first air layer 57 or the second end surface 50d of the wavelength conversion element 50.

On the other hand, the fluorescence Y which travels toward the −X side to reach the first reflective member 53 is reflected by the first reflective member 53, and then travels toward the +X side, repeats reflection between the first optical layer 52 of the first optical member 55 and the reverse surface 50b of the wavelength conversion element 50, and is then emitted from the region at the second end surface 50d side of the first air layer 57 or the second end surface 50d of the wavelength conversion element 50.

In contrast, fluorescence Y3 which enters the obverse surface 50a of the wavelength conversion element 50 at an incident angle equal to or greater than the critical angle is reflected by the obverse surface 50a and is guided inside the wavelength conversion element 50. In the case of the present embodiment, since the wavelength conversion element 50 is formed of a transparent phosphor, scattering of the fluorescence Y3 does not occur inside the wavelength conversion element 50, and the incident angle of the fluorescence Y3 with respect to the obverse surface 50a of the wavelength conversion element 50 does not change. Therefore, the fluorescence Y3 traveling toward the +X side is repeatedly reflected between the obverse surface 50a and the reverse surface 50b of the wavelength conversion element 50 and is then emitted from the second end surface 50d. Meanwhile, similarly to the fluorescence Y2 traveling through the first air layer 57, fluorescence Y4 which travels toward the −X side is reflected by the first reflective member 53, then travels toward the +X side, repeats reflection between the obverse surface 50a and the reverse surface 50b of the wavelength conversion element 50, and is emitted from the second end surface 50d.

In the light source device 30A, the fluorescence Y1 and the fluorescence Y2 as a part of the fluorescence Y generated by the wavelength conversion element 50 are emitted from the region at the second end surface 50d side of the first air layer 57, and the fluorescence Y3 and the fluorescence Y4 as another part of the fluorescence Y are emitted from the second end surface 50d of the wavelength conversion element 50. In such a manner, the light source device 30A can output the fluorescence Y generated by the wavelength conversion element 50 to the outside from the light drawing port 31k of the housing 31.

As illustrated in FIG. 2, in a state of a plan view in the X-axis direction as the normal direction of the second end surface 50d of the wavelength conversion element 50, the light drawing port 31k overlaps the first air layer 57 and the wavelength conversion element 50. Accordingly, the region at the second end surface 50d side of the first air layer 57 and the second end surface 50d of the wavelength conversion element 50 are exposed to the outside through the light drawing port 31k. It is possible to adopt a configuration in which the light drawing port 31k is closed by a lid formed of a light transmissive member, and the region at the second end surface 50d side of the first air layer 57 and the second end surface 50d of the wavelength conversion element 50 are not exposed to the outside. However, when the lid is provided, a part of the fluorescence Y may be reflected by a surface of the lid and may not be drawn to the outside. Therefore, in order to increase a drawing efficiency of the fluorescence Y, it is desirable that the lid is not provided. The light drawing port 31k overlaps also the first optical layer 52 in addition to the first air layer 57 and the wavelength conversion element 50 in the example in FIG. 2, but is not required to overlap the first optical layer 52.

As described above, the light source device 30A can draw the fluorescence Y, which is emitted from the region at the second end surface 50d side of the first air layer 57 and the second end surface 50d of the wavelength conversion element 50, to the outside through the light drawing port 31k which is as small as possible. Accordingly, in the light source device 30A, the etendue of the fluorescence Y is reduced, and the loss of the fluorescence Y in an optical member disposed in the posterior stage of the light source device 30A such as the integrator optical system 70 can be reduced. As a result, the use efficiency of the fluorescence Y in the light source device 30A can be improved.

Advantages of the propagation of the fluorescence Y through the first air layer 57 will hereinafter be described.

FIG. 5 is a schematic diagram illustrating the operation of the light source device 30A according to the present embodiment.

It is conceivable to adopt a configuration in which when the fluorescence Y emitted from the wavelength conversion element 50 is guided to the light drawing port 31k through any of the media, a light transmissive member made such as quartz is made adjacent to the wavelength conversion element 50 instead of such an air layer as in the present embodiment, and the fluorescence is guided through the light transmissive member. This configuration is referred to as a comparative example.

In the case of the comparative example, as shown in FIG. 5, when the fluorescence Y generated by the wavelength conversion element 50 reaches an interface K between the wavelength conversion element 50 and the light transmissive member 60, the fluorescence Y is refracted at the refraction angle β1 without being reflected by the interface K and enters the light transmissive member 60 as long as the incident angle α of the fluorescence Y with respect to the interface K is less than the critical angle. Here, assuming that the material of the wavelength conversion element 50 is YAG and the material of the light transmissive member 60 is quartz, since the refractive index of YAG is about 1.7 and the refractive index of quartz is about 1.4, the refractive index difference between the wavelength conversion element 50 and the light transmissive member 60 is about 0.3, which is relatively small.

In this case, the refraction angle β1 is not so large with respect to the incident angle α, and fluorescence Y5 which enters the light transmissive member 60 travels in a direction close to perpendicular to the interface K, that is, a direction forming a large angle with respect to the X axis. As a result, there is a possibility that the fluorescence Y5 leaks to the outside from a surface 60b at the side opposite to the interface K of the light transmissive member 60, and becomes leakage light Y6. Alternatively, even when the fluorescence Y5 becomes fluorescence Y7 which is reflected by the surface 60b of the light transmissive member 60, since the incident angle of the fluorescence Y7 with respect to the end surface 60d is large when the fluorescence Y7 propagates through the light transmissive member 60 in the X-axis direction and reaches the end surface 60d of the light transmissive member 60, there is a possibility that the fluorescence Y7 is reflected by the end surface 60d and is not emitted from the end surface 60d, and the drawing efficiency of the fluorescence Y decreases.

In contrast, when the first air layer 57 is made adjacent to the wavelength conversion element 50 as in the present embodiment, since the refractive index of YAG is about 1.7 and the refractive index of air is about 1.0, the refractive index difference between the wavelength conversion element 50 and the first air layer 57 is about 0.7, which is larger than that in the case of the comparative example. Therefore, a refraction angle 32 becomes larger than the refraction angle β1, and fluorescence Y8 which enters the first air layer 57 travels in a direction forming a smaller angle with respect to the interface K, that is, a direction forming a smaller angle with respect to the X axis, compared to when the fluorescence Y8 enters the light transmissive member 60. As a result, when the fluorescence Y8 reaches the interface between the first air layer 57 and another substance, the fluorescence Y8 becomes easy to be totally reflected and difficult to leak to the outside. Further, in the case of the present embodiment, since the first air layer 57 is opened to the external space in the light drawing port 31k and has no refractive index interface, the fluorescence Y8 that has reached the light drawing port 31k is emitted to the external space as it is without causing reflection or refraction. Due to the action described above, according to the light source device 30A related to the present embodiment, the drawing efficiency of the fluorescence Y can be improved.

### Advantages of First Embodiment

The light source device 30A according to the present embodiment includes the first light source 41 that emits the excitation light E, the wavelength conversion element 50 that converts the excitation light E into the fluorescence Y, the first optical member 55 that is disposed between the first light source 41 and the wavelength conversion element 50 and transmits the excitation light E while reflecting the fluorescence Y, and the first reflective member 53 that reflects the excitation light E and the fluorescence Y. The first air layer 57 is disposed between the first optical member 55 and the wavelength conversion element 50. The wavelength conversion element 50 has the obverse surface 50a on which the excitation light E is incident via the first optical member 55 and the first air layer 57, the reverse surface 50b facing to the opposite side to the obverse surface 50a, and the first end surface 50c and the second end surface 50d that cross the obverse surface 50a and the reverse surface 50b and face to respective sides opposite to each other. The first reflective member 53 is disposed in the region at the first end surface 50c side of the first air layer 57. The fluorescence Y emitted from the obverse surface 50a of the wavelength conversion element 50 propagates through the first air layer 57 and is then emitted from the region of the second end surface 50d of the first air layer 57.

As described above, according to the light source device 30A related to the present embodiment, since a part of the fluorescence Y generated by the wavelength conversion element 50 propagates through the first air layer 57 and is emitted from the region of the second end surface 50d of the first air layer 57, the loss of the fluorescence Y is smaller compared to, for example, the light source device according to the comparative example in which the fluorescence Y propagates through the inside of the light transmissive member, and it is possible to increase the use efficiency of the fluorescence Y.

The projector 1 according to the present embodiment includes the light source device 30A, the light modulation devices 4R, 4G, and 4B that modulate the light emitted from the light source device 30A, and the projection optical device 6 that projects the light modulated by the light modulation devices 4R, 4G, and 4B.

According to this configuration, the projector 1 high in light use efficiency can be realized.

### Second Embodiment

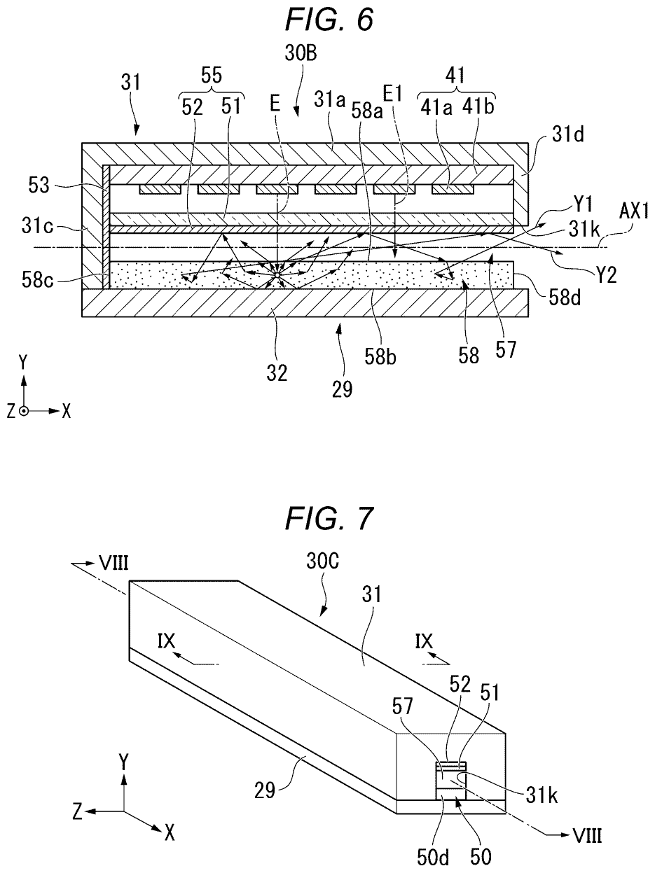

A second embodiment of the present disclosure will hereinafter be described using FIG. 6.

A projector and a light source device according to the second embodiment are substantially the same as those of the first embodiment in basic configuration, and are different from the first embodiment in the configuration of the wavelength conversion element. Therefore, descriptions of the basic configurations of the projector and the light source device will be omitted.

FIG. 6 is a cross-sectional view of the light source device 30B according to the second embodiment in the state of being cut along the X-Y plane. In FIG. 6, the elements common to those in the drawing used in the description of the first embodiment will be denoted by the same reference symbols to omit the description thereof.

As shown in FIG. 6, the light source device 30B according to the present embodiment includes the support member 29, the housing 31, the first light source 41, a wavelength conversion element 58, the first optical member 55, the first reflective member 53, and the second reflective members (not shown).

In the light source device 30A according to the first embodiment, the wavelength conversion element 50 is made of a transparent phosphor. In contrast, in the light source device 30B according to the present embodiment, the wavelength conversion element 58 is formed of a phosphor having a light scattering property. The phosphor having a light scattering property can be realized by dispersing a medium different in refractive index from the transparent phosphor, for example, a scattering body such as gas pockets or fillers, in the transparent phosphor. The wavelength conversion element 58 has an obverse surface 58a, a reverse surface 58b, a first end surface 58c, and a second end surface 58d.

Other configurations of the light source device 30B are substantially the same as those of the light source device 30A according to the first embodiment.

### Advantages of Second Embodiment

Also in the present embodiment, it is possible to obtain substantially the same advantages as those of the first embodiment such as the advantage that it is possible to realize the light source device 30B in which the fluorescence Y propagates through the first air layer 57 to thereby make the loss of the fluorescence Y small and achieve the excellent use efficiency of the fluorescence Y.

Further, in the case of the present embodiment, since the wavelength conversion element 58 is formed of a phosphor having the light scattering property, the following advantages can be obtained.

In the case of the first embodiment, since the wavelength conversion element 50 is formed of a transparent phosphor, scattering does not occur when the fluorescence Y propagates inside the wavelength conversion element 50, and the traveling direction of the fluorescence Y does not change. Therefore, the fluorescence Y incident on the obverse surface 50a of the wavelength conversion element 50 at an incident angle less than the critical angle repeats the total reflection at the same incident angle. In this manner, the fluorescence Y propagates in a state of being confined inside the wavelength conversion element 50, and is then emitted from the second end surface 50d.

In contrast, in the case of the present embodiment, since the wavelength conversion element 58 is configured with the phosphor having the light scattering property, a lot of scattering occurs when the fluorescence Y propagates inside the wavelength conversion element 58, and the traveling direction of the fluorescence Y changes every time the fluorescence Y is scattered.

Therefore, the fluorescence Y1 reflected by the first optical layer 52 of the first optical member 55 and incident on the wavelength conversion element 58 enters the first air layer 57 in the state of being scattered by the wavelength conversion element 58 and subjected to angle conversion, and is then emitted from the region at the second end surface 58d side of the first air layer 57. The fluorescence Y2 as a part thereof is reflected again by the first optical layer 52 of the first optical member 55 via the first air layer 57 to thereby be emitted from the region at the second end surface 58d side of the first air layer 57.

In this way, the fluorescence Y is drawn to the first air layer 57 without being confined inside the wavelength conversion element 58, and is emitted from the region at the second end surface 58d side of the first air layer 57. That is, the fluorescence Y propagates inside the first air layer 57 while repeating scattering by the wavelength conversion element 58 and reflection by the first optical member 55, and is then emitted from the region at the second end surface 58d side of the first air layer 57. As a result, since the loss when the fluorescence Y propagates through the wavelength conversion element 58 is suppressed, the use efficiency of the fluorescence Y can further be increased compared to the first embodiment.

In the case of the present embodiment, as long as substantially whole of the fluorescence Y is emitted from the first air layer 57 to the outside, it is possible to adopt a configuration in which only the first air layer 57 is exposed without exposing the wavelength conversion element 58 from the light drawing port 31k. According to this configuration, it is possible to make the light drawing port 31k smaller to reduce the etendue of the fluorescence Y.

### Third Embodiment

A third embodiment of the present disclosure will hereinafter be described using FIG. 7 to FIG. 9.

A projector and a light source device according to the third embodiment are substantially the same as those of the first embodiment in basic configuration, and are different from the first embodiment in the configuration of the first optical member. Therefore, descriptions of the basic configurations of the projector and the light source device will be omitted.

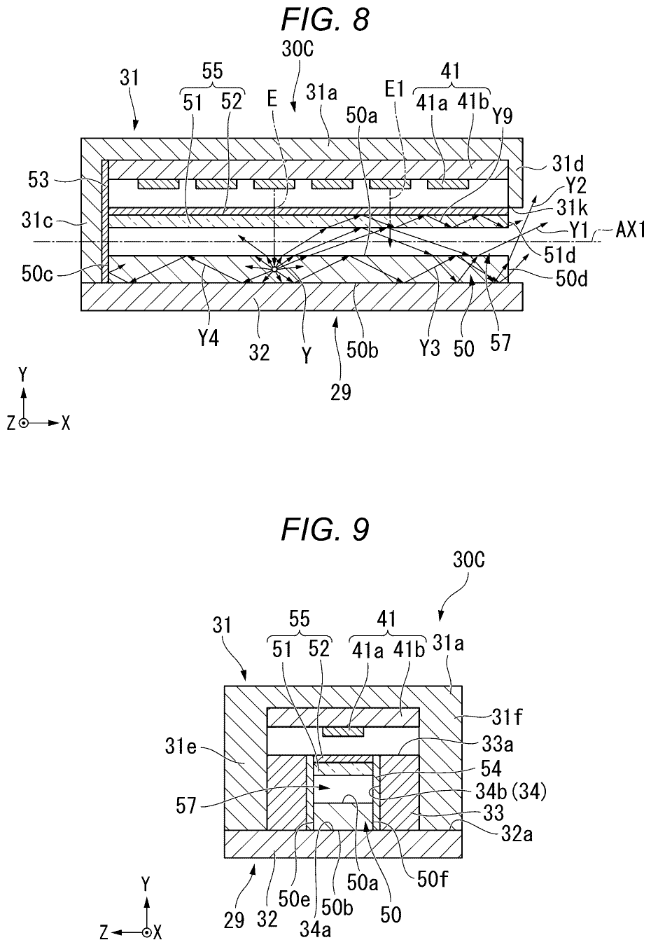

FIG. 7 is a perspective view of a light source device 30C according to the third embodiment. FIG. 8 is a cross-sectional view of the light source device 30C along the line VIII-VIII in FIG. 7. FIG. 9 is a cross-sectional view of the light source device 30C along the line IX-IX in FIG. 7.

In FIG. 7 to FIG. 9, the elements common to those in the drawings used in the description of the first embodiment will be denoted by the same reference symbols to omit the description thereof.

As shown in FIG. 7 to FIG. 9, the light source device 30C according to the present embodiment includes the support member 29, the housing 31, the first light source 41, the wavelength conversion element 50, the first optical member 55, the first reflective member 53, and the second reflective members 54.

In the light source device 30C according to the present embodiment, the first optical member 55 is disposed oppositely to the first optical member 55 of the first embodiment. That is, as shown in FIG. 8, the first optical layer 52 is disposed on a surface of the first transmissive member 51 facing the first light source 41.

In the case of the present embodiment, the behavior of light is different from that in the first embodiment. That is, as shown in FIG. 8, since the first optical layer 52 is disposed on the surface at an opposite side to the first air layer 57 of the first light transmissive member 51, a part of the fluorescence propagating through the first air layer 57 enters the first light transmissive member 51. Out of the fluorescence Y incident on the first light transmissive member 51, fluorescence Y9 which is incident on the interface between the first light transmissive member 51 and the first air layer 57 at an angle less than the critical angle is guided inside the first light transmissive member 51 while repeating total reflection, and is then emitted from the end surface 51d.

Further, the fluorescence Y1 reflected by the first light transmissive member 51 enters the wavelength conversion element 50, is then reflected by the reverse surface 50b of the wavelength conversion element 50 to enter the first air layer 57 from the obverse surface 50a of the wavelength conversion element 50, and is then emitted from the region at the second end surface 50d side of the first air layer 57. Further, the fluorescence Y2 reflected by the first light transmissive member 51 enters the wavelength conversion element 50, is then reflected by the reverse surface 50b of the wavelength conversion element 50, and is then emitted from the second end surface 50d.

Therefore, as illustrated in FIG. 7, in a state of a plan view in the X-axis direction as the normal direction of the second end surface 50d of the wavelength conversion element 50, the light drawing port 31k overlaps the first air layer 57, the wavelength conversion element 50, and the first light transmissive member 51. Accordingly, the region at the second end surface 50d side of the first air layer 57, the second end surface 50d of the wavelength conversion element 50, and the end surface 51d of the first light transmissive member 51 are exposed to the outside through the light drawing port 31k. As described above, in the light source device 30C according to the present embodiment, most of the fluorescence Y is emitted from the region at the second end surface 50d side of the first air layer 57, another part of the fluorescence Y is emitted from the second end surface 50d of the wavelength conversion element 50, and still another part of the fluorescence Y is emitted from the end surface 51d of the first light transmissive member 51.

Other configurations of the light source device 30C are substantially the same as those of the light source device 30A according to the first embodiment.

### Advantages of Third Embodiment

Also in the present embodiment, it is possible to obtain substantially the same advantages as those of the first embodiment such as the advantage that it is possible to realize the light source device 300 in which the fluorescence Y propagates through the first air layer 57 to thereby make the loss of the fluorescence Y small and achieve the excellent use efficiency of the fluorescence Y.

### Fourth Embodiment

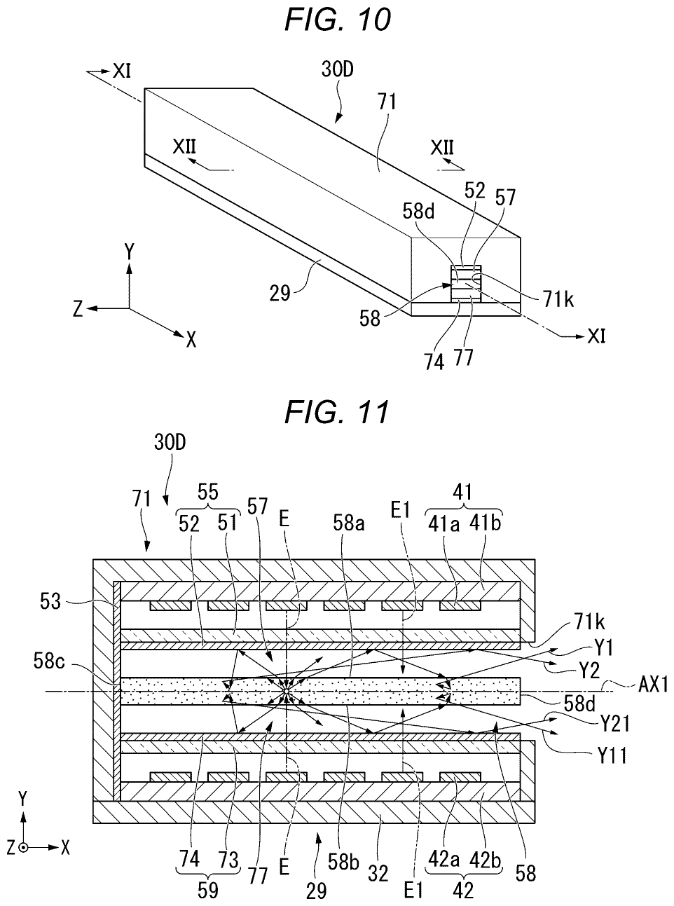

A fourth embodiment of the present disclosure will hereinafter be described using FIG. 10 to FIG. 12.

A projector and a light source device according to the fourth embodiment are substantially the same as those of the first embodiment in basic configuration, and are different from the first embodiment in that a second light source and a second optical member are added. Therefore, descriptions of the basic configurations of the projector and the light source device will be omitted.

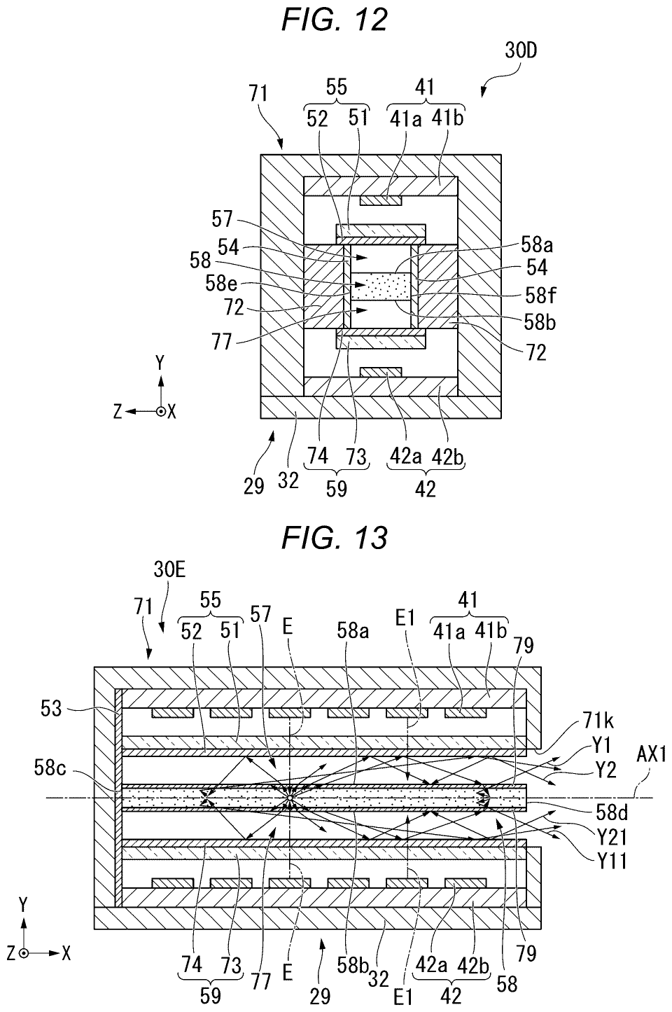

FIG. 10 is a perspective view of a light source device 30D according to the fourth embodiment. FIG. 11 is a cross-sectional view of the light source device 30D along the line XI-XI in FIG. 10. FIG. 12 is a cross-sectional view of the light source device 30D along the line XII-XII in FIG. 10.

In FIG. 10 to FIG. 12, the elements common to those in the drawings used in the description of the preceding embodiments will be denoted by the same reference symbols to omit the description thereof.

As shown in FIG. 10 to FIG. 12, the light source device 30D according to the present embodiment includes the support member 29, a housing 71, the first light source 41, a second light source 42, the wavelength conversion element 58, the first optical member 55, a second optical member 59, the first reflective member 53, and the second reflective members 54. In the present embodiment, similarly to the second embodiment, the wavelength conversion element 58 is formed of a phosphor having a light scattering property.

As shown in FIG. 11, in the cross-sectional structure viewed from the Z-axis direction, the configuration at the +Y side from the central axis of the wavelength conversion element 58 is the same as that in the second embodiment. That is, the first light source 41 is disposed to be opposed to the surface 58a of the wavelength conversion element 58 and emits the excitation light E toward the wavelength conversion element 58. The first optical member 55 is disposed between the first light source 41 and the wavelength conversion element 58. The wavelength conversion element 58 and the first optical member 55 are not in contact with each other, and the first air layer 57 is provided between the wavelength conversion element 58 and the first optical member 55. The excitation light E emitted from the first light source 41 is transmitted through the first optical member 55 and enters the wavelength conversion element 58 via the first air layer 57.

In contrast, the configuration at the −Y side from the central axis of the wavelength conversion element 58 is different from that of the second embodiment. As shown in FIG. 12, in the light source device 30D according to the present embodiment, the wavelength conversion element 58 is supported by a pair of support parts 72 provided to the housing 71. A reverse surface 58b of the wavelength conversion element 58 is not in contact with the support member 29.

The second light source 42 includes a plurality of second light emitting elements 42a and a substrate 42b. The plurality of second light emitting elements 42a is mounted on the substrate 42b. Note that the number of second light emitting elements 42a is not particularly limited, and may be different from the number of first light emitting elements 41a. Accordingly, the second light source 42 is not necessarily required to include the plurality of second light emitting elements 42a, and may include a single second light emitting element 42a.

The second light emitting elements 42a each emit the excitation light beam E1 in the first wavelength band. The second light emitting element 42a is configured with substantially the same LED as that of the first light emitting element 41a. The second light emitting element 42a is disposed to be opposed to the reverse surface 58b of the wavelength conversion element 58 and emits the excitation light beam E1 toward the wavelength conversion element 58. In this manner, the second light source 42 emits the excitation light E consisting of the plurality of blue excitation light beams E1 toward the wavelength conversion element 58.

The second optical member 59 is disposed between the second light source 42 and the wavelength conversion element 58. Specifically, the second optical member 59 is disposed on surfaces of the support parts 72 opposed to the second light source 42. The second optical member 59 includes a second light transmissive member 73 and a second optical layer 74. The second optical layer 74 is disposed on a surface opposed to the second light source 42 out of the two surfaces of the second light transmissive member 73.

The second light transmissive member 73 is formed of substantially the same light transmissive material as that of the first light transmissive member 51. Similarly to the first light transmissive member 51, the thermal conductivity of the second light transmissive member 73 is preferably higher than the thermal conductivity of the wavelength conversion element 58. According to this configuration, since the heat of the wavelength conversion element 58 is efficiently transferred to the second light transmissive member 73 via a second air layer 77, a rise in temperature of the wavelength conversion element 58 can be suppressed. Accordingly, it is possible to suppress a decrease in light emission efficiency due to a rise in temperature of the wavelength conversion element 58.

The second optical layer 74 is disposed between the wavelength conversion element 58 and the second light transmissive member 73. Similarly to the first optical layer 52, the second optical layer 74 has optical characteristics of transmitting the excitation light E and reflecting the fluorescence Y. The second optical layer 74 is disposed on a surface opposed to the wavelength conversion element 58 out of the two surfaces of the second light transmissive member 73. The second optical layer 74 is formed of substantially the same dielectric multilayer film as that of the first optical layer 52.

The second air layer 77 is provided between the second optical member 59 and the wavelength conversion element 58. That is, the second optical member 59 and the wavelength conversion element 58 are disposed apart from each other, and air is present between the second optical member 59 and the wavelength conversion element 58.

The first reflective member 53 is disposed at the −X side in the X-axis direction of the wavelength conversion element 58, the first air layer 57, the first optical member 55, the first light source 41, the second air layer 77, the second optical member 59, and the second light source 42. Note that the first reflective member 53 is not required to be disposed over the entire region described above, and is sufficiently disposed in at least a region at the first end surface 58c side of the first air layer 57 and a region at the first end surface 58c side of the second air layer 77.

As shown in FIG. 10, in a state of a plan view in the X-axis direction, a light drawing port 71k overlaps the first air layer 57, the wavelength conversion element 58, and the second air layer 77. Accordingly, the region at the second end surface 58d side of the first air layer 57, the second end surface 58d of the wavelength conversion element 58, and a region at the second end surface 58d side of the second air layer 77 are exposed to the outside through the light drawing port 71k.

Other configurations of the light source device 30D are substantially the same as those of the light source device 30B according to the second embodiment.

The behavior of the light in the light source device 30D according to the present embodiment will hereinafter be described.

In the light source device 30D according to the present embodiment, since the behaviors of the excitation light E emitted from the first light source 41 and the fluorescence Y generated by the wavelength conversion element 58 are substantially the same as those in the second embodiment, the behavior of the excitation light E emitted from the second light source 42 will briefly be described.

The excitation light E emitted from the second light source 42 is transmitted through the second optical member 59, and enters the wavelength conversion element 58 from the reverse surface 58b via the second air layer 77. Out of the fluorescence Y emitted from any of light emitting points in the wavelength conversion element 58 toward-Z side, the fluorescence Y incident on the reverse surface 58b of the wavelength conversion element 58 at an incident angle less than the critical angle is emitted from the wavelength conversion element 58 and enters the second air layer 77. On this occasion, fluorescence Y11 which is reflected by the second optical layer 74 of the second optical member 59 to enter the wavelength conversion element 58 is incident on the second air layer 77 in a state of being scattered by the wavelength conversion element 58 and subjected to the angle conversion, and is then emitted from the region at the second end surface 58d side of the second air layer 77. The fluorescence Y21 as a part thereof is reflected again by the second optical layer 74 of the second optical member 59 via the second air layer 77 to thereby be emitted from the region at the second end surface 58d side of the second air layer 77. Meanwhile, the fluorescence Y traveling toward the −X side and reaching the first reflective member 53 is reflected by the first reflective member 53, then travels toward the +X side, propagates inside the second air layer 77 while repeating scattering by the wavelength conversion element 58 and reflection by the second optical member 59, and is then emitted from the region at the second end surface 58d side of the second air layer 77.

As described above, in the light source device 30D according to the present embodiment, a part of the fluorescence Y generated by the wavelength conversion element 58 is emitted from the region at the second end surface 58d side of the first air layer 57, and another part of the fluorescence Y is emitted from the region at the second end surface 58d side of the second air layer 77. Therefore, the light source device 30D is capable of efficiently emitting the fluorescence Y generated by the wavelength conversion element 58 to the outside from the light drawing port 71k of the housing 71.

### Advantages of Fourth Embodiment

The light source device 30D of the present embodiment further includes the second light source 42 that is disposed so as to be opposed to the reverse surface 58b and emits the excitation light E, and the second optical member 59 that is disposed between the second light source 42 and the wavelength conversion element 58, transmits the excitation light E, and reflects the fluorescence Y. The second air layer 77 is provided between the second optical member 59 and the wavelength conversion element 58. The excitation light E transmitted through the second optical member 59 enters the wavelength conversion element 58 from the reverse surface 58b via the second air layer 77. The first reflective member 53 is disposed in the region at the first end surface 58c side of the second air layer 77. The fluorescence Y emitted from the reverse surface 58b of the wavelength conversion element 58 propagates through the second air layer 77 and is then emitted from the region at the second end surface 58d side of the second air layer 77.

Also in the present embodiment, it is possible to obtain substantially the same advantages as those of the first embodiment such as the advantage that it is possible to realize the light source device 30D in which the fluorescence Y propagates through the first air layer 57 to thereby make the loss of the fluorescence Y small and achieve the excellent use efficiency of the fluorescence Y.

Further, in the case of the present embodiment, the excitation light E which is emitted from the second light source 42 and then enters the reverse surface 58b of the wavelength conversion element 58 is emitted as the fluorescence Y from the light emitting point in the vicinity of the reverse surface 58b, and the fluorescence Y is emitted to the external space from the region at the second end surface 58d side of the second air layer 77. As described above, according to the present embodiment, since the excitation light E is incident on both the obverse surface 58a and the reverse surface 58b of the wavelength conversion element 58, the incident amount of the excitation light E can be increased. Here, as the length of the wavelength conversion element 58 in the X-axis direction increases, it becomes more difficult to draw the fluorescence Y generated in a region at an opposite side to the light drawing port 71k. Therefore, when the length in the X-axis direction of the wavelength conversion element 58 is increased to increase the incident area of the excitation light E, there is a possibility that the fluorescence Y may not efficiently be drawn. In contrast, in the present embodiment, the fluorescence Y can efficiently be drawn while increasing the fluorescence conversion efficiency by increasing the incident amount of the excitation light E without increasing the length in the X-axis direction of the wavelength conversion element 58.

In the light source device 30A according to the first embodiment, there is adopted the configuration of returning the fluorescence Y to the inside of the wavelength conversion element 50 with a reflective film formed on the reverse surface 50b of the wavelength conversion element 50, but since the reflective film formed on the reverse surface 50b having asperity is difficult to obtain a sufficient film performance, absorption of light is apt to occur. In contrast, in the case of the present embodiment, the fluorescence Y emitted from the reverse surface 58b of the wavelength conversion element 58 is reflected between the second optical layer 74 and the wavelength conversion element 58 to propagate through the second air layer 77, and therefore, it is possible to efficiently draw the fluorescence Y. In addition, since the second optical layer 74 is formed on the surface of the second light transmissive member 73 formed of a smooth surface, it is easy to enhance the film performance, and it is possible to form the second optical layer 74 that efficiently reflects the fluorescence Y.

### Fifth Embodiment

A fifth embodiment of the present disclosure will hereinafter be described using FIG. 13.

The fifth embodiment is substantially the same as the fourth embodiment in basic configuration of the light source device, and is different from the fourth embodiment in that reflection suppression layers are added. Therefore, the description of the basic configuration of the light source device will be omitted.

FIG. 13 is a cross-sectional view of a light source device 30E according to the fifth embodiment.

In FIG. 13, the elements common to those in the drawing used in the description of the fourth embodiment will be denoted by the same reference symbols to omit the description thereof.

As shown in FIG. 13, the light source device 30E according to the present embodiment includes the support member 29, the housing 71, the first light source 41, the second light source 42, the wavelength conversion element 58, the first optical member 55, the second optical member 59, the first reflective member 53, the second reflective members (not shown), and reflection suppression layers 79.

The reflection suppression layers 79 are disposed between first light source 41 and the wavelength conversion element 58, and between the second light source 42 and the wavelength conversion element 58, respectively. Specifically, the reflection suppression layers 79 are disposed respectively on the obverse surface 58a and the reverse surface 58b of the wavelength conversion element 58. The reflection suppression layers 79 each have a characteristic of absorbing the excitation light E to suppress the reflection of the excitation light E on the obverse surface 58a and the reverse surface 58b of the wavelength conversion element 58. The reflection suppression layer 79 is formed of an optical coating, a dielectric film, or the like for general reflection suppression purposes. Note that the reflection suppression layer 79 may be disposed on a surface of the first light transmissive member 51 at the side opposed to the first light source 41, a surface of the second light transmissive member 73 at the side opposed to the second light source 42, or the like, in addition to the places described above.

Other configurations of the light source device 30E are substantially the same as those of the light source device 30D according to the fourth embodiment.

### Advantages of Fifth Embodiment

Also in the present embodiment, it is possible to obtain substantially the same advantages as those of the first embodiment such as the advantage that it is possible to realize the light source device 30E in which the fluorescence Y propagates through the first air layer 57 to thereby make the loss of the fluorescence Y small and achieve the excellent use efficiency of the fluorescence Y.

In the case of the first to fourth embodiments described above, when the blue excitation light E emitted from the first light source 41 enters the wavelength conversion element 50, 58, for example, since the refractive index difference between the first air layer 57 and the wavelength conversion element 50, 58 is large, some of the excitation light E is reflected by the obverse surface of the wavelength conversion element 50, 58. Therefore, the amount of excitation light E making a substantive contribution to the wavelength conversion decreases, and the wavelength conversion efficiency decreases. Further, the excitation light E reflected by the obverse surface of the wavelength conversion element 50, 58 is transmitted through the first optical layer 52, and therefore enters the first light emitting element 41a and the peripheral members thereof to be converted into heat. As a result, a problem such as a decrease in light emission efficiency of the first light emitting element 41a occurs.

In contrast, in the case of the present embodiment, since the reflection suppression layers 79 are disposed respectively on the obverse surface 58a and the reverse surface 58b of the wavelength conversion element 58, the amount of excitation light E making a substantive contribution to the wavelength conversion increases, and the wavelength conversion efficiency is improved. In addition, the reflection of the excitation light E on the surfaces 58a, 58b of the wavelength conversion element 58 is suppressed, and the rise in temperature of the first light source 41 and the second light source 42 is suppressed. Accordingly, it is possible to solve the problem such as the decrease in the light emission efficiency of the first light emitting element 41a and the second light emitting element 42a. Further, since the reflection of the fluorescence Y incident on the first air layer 57 and the second air layer 77 from the wavelength conversion element 58 is suppressed, reabsorption of the fluorescence Y inside the wavelength conversion element 58 is reduced, and the drawing efficiency of the fluorescence Y can be improved.

Note that the technical scope of the present disclosure is not limited to the embodiments described above, and a variety of modifications can be made thereto without departing from the intent of the present disclosure.

In the embodiments described above, the first optical member is configured with the first light transmissive member and the first optical layer, but instead of this configuration, the first optical member may be configured with a single optical member having characteristics of transmitting the excitation light and reflecting the fluorescence. That is, the first optical member is not necessarily required to have the first light transmissive member. Examples of the optical member of this kind include a hologram, and an optical film designed to stand by itself as a film alone.

Further, as the constituent material of the wavelength conversion element, it is possible to use, for example, a composite phosphor containing AlN and Ce: YAG. According to this configuration, even in a configuration in which the contact area between the wavelength conversion element and the support member, and the contact area between the wavelength conversion element and the housing are too small to secure a large number of heat dissipation paths as in the above embodiments, it is possible to increase the thermal conductivity of the wavelength conversion element compared to when using a phosphor made of Ce: YAG alone. This can increase the cooling efficiency of the wavelength conversion element. Accordingly, the maximum amount of excitation light can be increased, and the maximum output of fluorescence can be increased.

In addition, in the embodiments described above, there is cited an example in which the wavelength conversion element is made of a yellow phosphor and blue excitation light is converted into the yellow fluorescence, but instead of this configuration, it is possible to adopt a configuration in which the wavelength conversion element is formed of a blue phosphor, and ultraviolet excitation light is converted into blue fluorescence. In this case, the first light emitting element emits the excitation light in an ultraviolet wavelength band of, for example, 100 nm to 400 nm having a peak wavelength of 380 nm. The wavelength conversion element is configured with a blue phosphor that converts the ultraviolet light emitted from the first light source into blue fluorescence having a blue wavelength band of, for example, 450 to 495 nm. As the blue phosphor, there is used, for example, BaMgAl₁₀O₁₇: Eu (II). The blue fluorescence propagates inside the first air layer while repeating scattering by the wavelength conversion element and the reflection by the first optical member, and is then emitted from a region at the fourth surface side of the first air layer.

Besides the above, the specific descriptions of the shapes, the numbers, the arrangements, the materials, and so on of the elements of the light source device and the projector are not limited to those in the embodiments described above and can be changed as appropriate. Further, in the embodiments described above, there is illustrated the example in which the light source device according to the present disclosure is installed in the projector using the liquid crystal panels, but this is not a limitation. The light source device according to the present disclosure may be applied to a projector using digital micromirror devices as the light modulation devices. Further, the projector is not required to include the plurality of light modulation devices and may include just a single light modulation device.

In the embodiments described above, there is illustrated the example in which the light source device according to the present disclosure is applied to the projector, but this is not a limitation. The light source device according to the present disclosure may be applied to a lighting apparatus, a headlight of an automobile, and so on.

### Summary of Present Disclosure

The present disclosure will hereinafter be summarized as additional remarks.

### Additional Remark 1

A light source device including
a first light source configured to emit first light in a first wavelength band,
a wavelength conversion element configured to convert the first light into second light in a second wavelength band different from the first wavelength band,
a first optical member which is disposed between the first light source and the wavelength conversion element and is configured to transmit the first light and reflect the second light, and
a first reflective member configured to reflect the first light and the second light, wherein
a first air layer is disposed between the first optical member and the wavelength conversion element,
the wavelength conversion element includes a first surface on which the first light is incident via the first optical member and the first air layer, a second surface facing to an opposite side to the first surface, and a third surface and a fourth surface which cross the first surface and the second surface, and facing to respective sides opposite to each other,
the first reflective member is disposed in a region at the third surface side of the first air layer, and
the second light emitted from the first surface of the wavelength conversion element propagates through the first air layer and is emitted from a region at the fourth surface side of the first air layer.

According to the configuration of Additional Remark 1, since the second light emitted from the first surface of the wavelength conversion element propagates through the first air layer, it is possible to realize the light source device small in loss of the second light and excellent in use efficiency of the second light.

### Additional Remark 2

The light source device according to Additional Remark 1, wherein
the first optical member includes a first light transmissive member configured to transmit the first light, and a first optical layer configured to transmit the first light and reflect the second light, and
the first optical layer is disposed on a surface of the first light transmissive member opposed to the wavelength conversion element.

According to the configuration of Additional Remark 2, since the second light does not propagate inside the first light transmissive member, the loss of the second light can be suppressed to the minimum.

### Additional Remark 3

The light source device according to Additional Remark 1, wherein
the first optical member includes a first light transmissive member configured to transmit the first light and the second light, and a first optical layer configured to transmit the first light and reflect the second light, and
the first optical layer is disposed on a surface of the first light transmissive member opposed to the first light source.

According to the configuration of Additional Remark 3, the second light can be drawn to the outside from both the first light transmissive member and the first air layer.

### Additional Remark 4

The light source device according to Additional Remark 2, wherein
a thermal conductivity of the first light transmissive member is higher than a thermal conductivity of the wavelength conversion element.

According to the configuration of Additional Remark 4, since the heat of the wavelength conversion element is efficiently transferred to the first light transmissive member via the first air layer, it is possible to suppress a decrease in light emission efficiency due to a rise in temperature of the wavelength conversion element.

### Additional Remark 5

The light source device according to Additional Remark 3, wherein
a thermal conductivity of the first light transmissive member is higher than a thermal conductivity of the wavelength conversion element.

According to the configuration of Additional Remark 5, since the heat of the wavelength conversion element is efficiently transferred to the first light transmissive member via the first air layer, it is possible to suppress a decrease in light emission efficiency due to a rise in temperature of the wavelength conversion element.

### Additional Remark 6

The light source device according to any one of Additional Remark 1 to Additional Remark 5, further including
a reflection suppression layer which is disposed between the first light source and the wavelength conversion element and is configured to suppress reflection of the first light by the first surface.

According to the configuration of Additional Remark 6, the amount of first light making a substantive contribution to the wavelength conversion increases, and the wavelength conversion efficiency is improved. In addition, since the reflection of the first light on the first surface of the wavelength conversion element is suppressed, the rise in temperature of the first light source due to the reflected light is suppressed. This suppresses a decrease in the light emission efficiency of the first light source.

### Additional Remark 7

The light source device according to any one of Additional Remark 1 to Additional Remark 6, further including
a second reflective member configured to reflect the first light and the second light, wherein
the wavelength conversion element includes a fifth surface and a sixth surface that cross the first surface, the second surface, the third surface, and the fourth surface, respectively, and face to respective sides opposite to each other, and
the second reflective member is disposed in a region at the fifth surface side of the first air layer and a region at the sixth surface side of the first air layer.

According to the configuration of Additional Remark 7, the conversion efficiency from the first light into the second light can be increased, and the loss of the second light can be suppressed.

### Additional Remark 8

The light source device according to any one of Additional Remark 1 to Additional Remark 7, further including
a support member configured to support the wavelength conversion element, wherein
the second surface is coupled to the support member so as to transfer heat.

According to the configuration of Additional Remark 8, since the heat generated in the wavelength conversion element is transferred to the support member, the rise in temperature of the wavelength conversion element is suppressed, and the wavelength conversion efficiency can be maintained.

### Additional Remark 9

The light source device according to Additional Remark 8, further including
a housing configured to cover the first optical member and the wavelength conversion element, wherein
the housing has a light drawing port through which the second light emitted from a region at the fourth surface side of the first air layer is drawn to an outside, and
the light drawing port overlaps the first air layer and the wavelength conversion element in a state of a plan view in a normal direction of the fourth surface of the wavelength conversion element.

According to the configuration of Additional Remark 9, it is possible to protect the first optical member and the wavelength conversion element with the housing, and to draw the second light propagating through the first air layer and the wavelength conversion element to the outside through the light drawing port of the housing.

### Additional Remark 10

The light source device according to any one of Additional Remark 1 to Additional Remark 7, further including
a second light source which is disposed to be opposed to the second surface and is configured to emit the first light, and
a second optical member which is disposed between the second light source and the wavelength conversion element and is configured to transmit the first light and reflect the second light, wherein
a second air layer is disposed between the second optical member and the wavelength conversion element,
the first light emitted from the second light source is incident on the second surface of the wavelength conversion element via the second optical member and the second air layer,
the first reflective member is disposed in a region at the third surface side of the second air layer, and
the second light emitted from the second surface of the wavelength conversion element propagates through the second air layer and is emitted from a region at the fourth surface side of the second air layer.

According to the configuration of Additional Remark 10, since the second light source is further provided, the amount of first light incident on the wavelength conversion element can be increased. As a result, the second light can be efficiently drawn using the second air layer while enhancing the wavelength conversion efficiency.

### Additional Remark 11

The light source device according to Additional Remark 10, further including
a housing configured to cover the first optical member, the wavelength conversion element, and the second optical member, wherein
the housing includes a light drawing port through which the second light emitted from a region at the fourth surface side of the first air layer and the second light emitted from a region at the fourth surface side of the second air layer are drawn to the outside, and
the light drawing port overlaps the first air layer, the wavelength conversion element, and the second air layer in a state of a plan view in a normal direction of the fourth surface of the wavelength conversion element.

According to the configuration of Additional Remark 11, it is possible to protect the first optical member, the wavelength conversion element, and the second optical member with the housing, and it is possible to draw the second light propagating through the first air layer, the wavelength conversion element, and the second air layer to the outside through the light drawing port of the housing.

### Additional Remark 12

The light source device according to any one of Additional Remark 1 to Additional Remark 11, wherein
the wavelength conversion element is formed of a transparent phosphor.

According to the configuration of Additional Remark 12, even when the wavelength conversion element made of the transparent phosphor is used, it is possible to efficiently draw the second light to the outside while increasing the conversion efficiency of the second light by increasing the incident amount of the first light without increasing the size of the wavelength conversion element.

### Additional Remark 13

The light source device according to any one of Additional Remark 1 to Additional Remark 11, wherein
the wavelength conversion element is formed of a phosphor having a light scattering property.

According to the configuration of Additional Remark 13, since the second light generated inside the wavelength conversion element is efficiently emitted to the first air layer and propagates through the first air layer, the loss of the second light is suppressed, and the drawing efficiency of the second light can further be improved.

### Additional Remark 14

The light source device according to Additional Remark 13, wherein
the wavelength conversion element is a yellow phosphor,
   the first light is blue light,
   the second light is yellow fluorescence, and
   the fluorescence propagates inside the first air layer
while repeating scattering by the wavelength conversion element and reflection by the first optical member and is emitted from a region at the fourth surface side of the first air layer.

According to the configuration of Additional Remark 14, the yellow fluorescence generated inside the wavelength conversion element can efficiently be drawn to the outside from the region at the fourth surface side of the first air layer.

### Additional Remark 15

The light source device according to Additional Remark 13, wherein
the wavelength conversion element is a blue phosphor,
the first light is ultraviolet light,
the second light is blue fluorescence, and
the fluorescence propagates inside the first air layer while repeating scattering by the wavelength conversion element and reflection by the first optical member and is emitted from a region at the fourth surface side of the first air layer.

According to the configuration of Additional Remark 15, the blue fluorescence generated inside the wavelength conversion element can efficiently be drawn to the outside from the region at the fourth surface side of the first air layer.

### Additional Remark 16

A projector including
the light source device described in any one of Additional Remark 1 to Additional Remark 15,
a light modulation device configured to modulate light emitted from the light source device, and
a projection optical device configured to project the light modulated by the light modulation device.

According to the configuration of Additional Remark 16, a projector excellent in light use efficiency can be realized.

What is claimed is:

1. A light source device comprising:
a first light source configured to emit first light in a first wavelength band;
a wavelength conversion element configured to convert the first light into second light in a second wavelength band different from the first wavelength band;
a first optical member which is disposed between the first light source and the wavelength conversion element and is configured to transmit the first light and reflect the second light; and
a first reflective member configured to reflect the first light and the second light, wherein
a first air layer is disposed between the first optical member and the wavelength conversion element,
the wavelength conversion element includes a first surface on which the first light is incident via the first optical member and the first air layer, a second surface facing to an opposite side to the first surface, and a third surface and a fourth surface which cross the first surface and the second surface, and facing to respective sides opposite to each other,
the first reflective member is disposed in a region at the third surface side of the first air layer, and
the second light emitted from the first surface of the wavelength conversion element propagates through the first air layer and is emitted from a region at the fourth surface side of the first air layer.

2. The light source device according to claim 1, wherein
the first optical member includes a first light transmissive member configured to transmit the first light, and a first optical layer configured to transmit the first light and reflect the second light, and
the first optical layer is disposed on a surface of the first light transmissive member opposed to the wavelength conversion element.

3. The light source device according to claim 1, wherein
the first optical member includes a first light transmissive member configured to transmit the first light and the second light, and a first optical layer configured to transmit the first light and reflect the second light, and
the first optical layer is disposed on a surface of the first light transmissive member opposed to the first light source.

4. The light source device according to claim 2, wherein
a thermal conductivity of the first light transmissive member is higher than a thermal conductivity of the wavelength conversion element.

5. The light source device according to claim 3, wherein
a thermal conductivity of the first light transmissive member is higher than a thermal conductivity of the wavelength conversion element.

6. The light source device according to claim 1, further comprising:
a reflection suppression layer which is disposed between the first light source and the wavelength conversion element and is configured to suppress reflection of the first light by the first surface.

7. The light source device according to claim 1, further comprising:
a second reflective member configured to reflect the first light and the second light, wherein
the wavelength conversion element includes a fifth surface and a sixth surface that cross the first surface, the second surface, the third surface, and the fourth surface, respectively, and face to respective sides opposite to each other, and
the second reflective member is disposed in a region at the fifth surface side of the first air layer and a region at the sixth surface side of the first air layer.

8. The light source device according to claim 1, further comprising:
a support member configured to support the wavelength conversion element, wherein
the second surface is coupled to the support member so as to transfer heat.

9. The light source device according to claim 8, further comprising:
a housing configured to cover the first optical member and the wavelength conversion element, wherein
the housing has a light drawing port through which the second light emitted from a region at the fourth surface side of the first air layer is drawn to an outside, and
the light drawing port overlaps the first air layer and the wavelength conversion element in a state of a plan view in a normal direction of the fourth surface of the wavelength conversion element.

10. The light source device according to claim 1, further comprising:
a second light source which is disposed to be opposed to the second surface and is configured to emit the first light; and
a second optical member which is disposed between the second light source and the wavelength conversion element and is configured to transmit the first light and reflect the second light, wherein
a second air layer is disposed between the second optical member and the wavelength conversion element,
the first light emitted from the second light source incident on the second surface of the wavelength is conversion element via the second optical member and the second air layer,
the first reflective member is disposed in a region at the third surface side of the second air layer, and
the second light emitted from the second surface of the wavelength conversion element propagates through the second air layer and is emitted from a region at the fourth surface side of the second air layer.

11. The light source device according to claim 10, further comprising:
a housing configured to cover the first optical member, the wavelength conversion element, and the second optical member, wherein
the housing includes a light drawing port through which the second light emitted from a region at the fourth surface side of the first air layer and the second light emitted from a region at the fourth surface side of the second air layer are drawn to the outside, and
the light drawing port overlaps the first air layer, the wavelength conversion element, and the second air layer in a state of a plan view in a normal direction of the fourth surface of the wavelength conversion element.

12. The light source device according to claim 1, wherein
the wavelength conversion element is formed of a transparent phosphor.

13. The light source device according to claim 1, wherein
the wavelength conversion element is formed of a phosphor having a light scattering property.

14. The light source device according to claim 13, wherein
the wavelength conversion element is a yellow phosphor,
the first light is blue light,
the second light is yellow fluorescence, and
the fluorescence propagates inside the first air layer while repeating scattering by the wavelength conversion element and reflection by the first optical member and is emitted from a region at the fourth surface side of the first air layer.

15. The light source device according to claim 13, wherein
the wavelength conversion element is a blue phosphor,
the first light is ultraviolet light,
the second light is blue fluorescence, and
the fluorescence propagates inside the first air layer while repeating scattering by the wavelength conversion element and reflection by the first optical member and is emitted from a region at the fourth surface side of the first air layer.

16. A projector comprising:
the light source device according to claim 1;
a light modulation device configured to modulate light emitted from the light source device; and
a projection optical device configured to project the light modulated by the light modulation device.
